(19) United States
(12) Patent Application Publication
(10) Pub. No.: US 2013/0081821 A1
(43) Pub. Date: Apr. 4, 2013

(54) Reinforcing Amorphous PLA with Solid Particles for Downhole Applications

(71) Applicants: Feng Liang, Cypress, TX (US); Rajesh K. Saini, Cypress, TX (US); Bradley L. Todd, Duncan, OK (US)

(72) Inventors: Feng Liang, Cypress, TX (US); Rajesh K. Saini, Cypress, TX (US); Bradley L. Todd, Duncan, OK (US)

(21) Appl. No.: 13/252,327

(22) Filed: Oct. 4, 2011

(51) Int. Cl. E21B 37/00; C08L 67/04; C09D 167/04; B82Y 99/00; B82Y 30/00

(52) U.S. Cl. 166/311; 525/450; 524/539; 977/742; 977/902

(57) ABSTRACT

The present invention relates to the use of composite material in downhole applications, and more particularly, relates to methods of making composite material comprising reinforced amorphous polylactic acid and methods of use related thereto. Some methods comprise providing an amorphous polylactic acid and a solid reinforcing material; forming a composite material by melting the amorphous polylactic acid and mixing it with the solid reinforcing material; and, using the composite material in a downhole application.

### BACKGROUND

The present invention relates to the use of composite material in downhole applications, and more particularly, relates to methods of making composite material comprising reinforced amorphous polylactic acid and methods of use related thereto.

Hydrocarbon wells are typically formed with a central wellbore that is supported by steel casing. However, there may also be open-hole portions in the well which are left open or unlined with casing. In open-hole completions with soft or poorly consolidated formations, the use of drill-in fluids, sand control screens, and/or cleanup systems for removal of the filter cake are often required to provide acceptable solids control and production rates.

One traditional method of controlling unconsolidated particulates in zones of a subterranean formation involves placing a filtration bed containing gravel particulates near the well bore that neighbors the zone of interest. A treatment fluid suspends gravel particulates to be deposited in a desired area in a well bore, e.g., near unconsolidated or weakly consolidated formation zones, to form a gravel pack to enhance sand control. The gravel particulates act, inter alia, to prevent the formation particulates from occluding the screen or migrating with the produced hydrocarbons. Often the gravel pack is held in place using a screen that acts, inter alia, to prevent the gravel particulates from entering the production tubing. Thus, gravel packs stabilize the formation while causing minimal impairment to well productivity. However, such packs may be time consuming and expensive to install.

The gravel pack screens (sometimes referred to as sand control screens) are available in a range of sizes and specifications, including dimensions, material type, and geometry. In order to effectively support gravel packing, the screen generally must be small enough to retain the gravel placed behind the screen, yet minimize any restriction to production of hydrocarbon. The production of a well is largely dependent on having the flow path in the screen remain open. The screen may however become plugged with various downhole materials, including bridging agents, polymers, drill solids, and drilling mud.

Various materials have been used to coat the screen in order to protect the flow channels of the screen. In a typical hydrocarbon producing wellbore, the downhole depth can range from a few hundred feet below the surface of the earth to more than 30,000 feet. In these settings, temperatures can easily range from 100° F. to over 350° F. Pressures will also significantly rise with depth. Thus, any material used in the coating of sand screens must be able to withstand the extreme temperatures and pressures of a downhole environment.

Amorphous polylactic acid (PLA) has been identified as a potential sand screen coating material because of its numerous desirable properties. One advantage of amorphous polylactic acid is that it is less brittle than many other coating materials such as a copolymer blend of polylactic acid and glycolic acid, which is extremely brittle. Amorphous polylactic acid may also be desirable because it readily degrades through hydrolysis. This degradation produces acids that can clean up potentially plugging materials such as calcium carbonate present in a filtercake. Amorphous polylactic acid is also relatively easy to manufacture and handle. The major downside of amorphous polylactic acid is that it deforms at relatively low temperatures (above its glass transition temperature, T_{g} 58° C. or 137° F.) and is not able to hold much differential pressure.

### SUMMARY OF THE INVENTION

The present invention relates to the use of composite material in downhole applications, and more particularly, relates to methods of making composite material comprising reinforced amorphous polylactic acid and methods of use related thereto.

Some embodiments of the present invention provide methods comprising: providing an amorphous polylactic acid and a solid reinforcing material; forming a composite material by melting the amorphous polylactic acid and mixing it with the solid reinforcing material; and, using the composite material in a downhole application.

Other embodiments of the present invention provide methods comprising: forming a composite material by melting an amorphous polylactic acid and mixing it with a solid reinforcing material; coating the composite material onto a screen for use in a downhole application such that the screen openings are substantially plugged; placing the coated screen into a wellbore wherein the coated screen acts as a wash pipe that gradually becomes a screen as the amorphous polylactic acid degrades.

Still other embodiments of the present invention provide methods comprising: providing a composite material by melting an amorphous polylactic acid and mixing it with a solid reinforcing material; and forming a downhole tubular with the composite material.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to those skilled in the art and having the benefit of this disclosure.

FIGS. 1A-1D show various views of an amorphous PLA wafer that was blown through at 180° F. under 100 psi as described in Example 2.

FIGS. 2A-2D show various views of an amorphous PLA wafer that was blown through 180° F. under 140 psi as described in Example 2.

FIGS. 3A-3D show various views of an amorphous PLA wafer after being treated at 150° F. under 200 psi for 2 hours as described in Example 2.

FIGS. 4A-4D show various views of an amorphous PLA wafer after being treated at 130° F. under 200 psi for 2 hours as described in Example 2.

FIG. 5 shows amorphous PLA wafer with a wrapped screen after being treated at 180° F. under 200 psi for 2 hours as described in Example 3.

FIGS. 6A-6C show DSC curves illustrating the glass transition temperatures and melting temperatures of amorphous PLA, crystalline PLA, and reinforced amorphous PLA.

FIG. 7 shows a reinforced amorphous PLA wafer with a wrapped screen after being treated at 180° F. under 200 psi for 2 hours.

FIGS. 8A-8B show a reinforced amorphous PLA wafer with a wrapped screen after being treated at 180° F. under 500 psi for 2 hours.

FIGS. 9A-9B show a reinforced amorphous PLA wafer after being treated with a slot model (1.5″×0.065″×0.125″) at 180° F. under 500 psi for 2 hours.

### DETAILED DESCRIPTION

The present invention relates to the use of composite material in downhole applications, and more particularly, relates to methods of making composite material comprising reinforced amorphous polylactic acid and methods of use related thereto.

As used herein, “composite” describes a material that has been made from two or more constituent materials with different properties that remain separate and distinct at the macroscopic or microscopic scale within the structure. A composite material may be naturally occurring or engineered. As used herein, “reinforced” describes a composite material that has been engineered to provide improved mechanical properties as compared to the individual components of the composite material. As used herein, “amorphous” describes a solid that is non-crystalline and lacks the long-range order characteristics of a crystal. Examples of amorphous solids include, but are not limited to, particles, rods, fibers, flakes, and thin films. For polylactic acid, the polymerization of racemic mixture of L- and D-lactides usually leads to the synthesis of poly-DL-lactide that is amorphous. The degree of crystallinity in the resulting reaction may be controlled by the ratio of D to L enantiomers used and/or type of catalyst used during the polymerization. This polymerization reaction may generate a wide range of molecular weights. Without being limited by theory, it is believed that polylactic acid may have both an amorphous portion, which is subject to glass transition, and a crystalline portion, which is subject to crystalline melting. In some cases, depending on the relative amounts of amorphous and crystalline portions, polylactic acid may be considered semi-crystalline. An amorphous material can undergo a reversible transition from a hard and relatively brittle state into a molten or rubber-like state at its glass transition temperature (T_{g}). Glass transition or liquid-glass transition is an amorphous polymer specific phenomenon that drastically affects the physical properties of a given polymer above and below T_{g}. Macroscopically, a material below its T_{g} is often hard and brittle whereas the same material above its T_{g} is often soft and flexible.

The composite material of amorphous polylactic acid reinforced with a solid reinforcing material to provide superior mechanical properties at elevated temperatures compared to amorphous polylactic acid alone. In fact, the composite material may be well suited for use in the present invention at temperatures above the glass transition temperature of amorphous polylactic acid while still being readily degradable. In certain downhole applications, such as gravel packing, it may be highly desirable to have materials that have strong mechanical properties, withstand extreme temperatures and pressures, and yet readily degrade. The reinforced amorphous polylactic acid of the present invention is particularly useful as coating material (e.g. on sand control screen) or a sealant. In some embodiments, the coating protects a sand control screen from plugging when introduced into a wellbore. This coating may degrade by hydrolysis to generate acids that can remove plugging materials such as calcium carbonate present in the filter cake. Compared to amorphous polylactic acid, the reinforced amorphous polylactic acid provides superior resistance against deformation and extrusion at higher temperatures and pressures. Yet because of its low glass transition temperature, the reinforced amorphous polylactic acid is not undesirably hard or brittle.

Moreover, the reinforced amorphous polylactic acid is generally impermeable and may be used to form an impermeable containment such as a wash pipe. That is, a screen can be coated with the reinforced composite such that the screen holes are completely or substantially plugged, thereby turning the screen into a pipe while the reinforced composite remains in place. Such completely or substantially plugged screens are then able to act as wash pipes for a period of time until the reinforced composite degrades, at which point it reverts to a screen form.

The reinforced amorphous polylactic acid is also a desirable material to use as a sealant under tough downhole conditions. The low T_{g} makes the reinforced amorphous polylactic acid readily pliable allowing the material to deform and seal. The reinforced amorphous polylactic acid is also easier to pump as compared to semi-crystalline polylactic acid at relatively high temperatures, particularly at temperatures lower than the melting point of semi-crystalline polylactic acid. Overall, the reinforced amorphous polylactic acid provides the advantage of both pumping ability to make the coating at relatively high temperatures while featuring relatively superior mechanical properties at lower operation temperatures. The reinforced amorphous polylactic acid also degrades faster than semi-crystalline polylactic acid. Without being limited by theory, it is believed that the amorphous portion of the composite material will degrade relatively fast and often leave the crystalline portion intact.

The present invention generally provides methods that comprise forming a composite material by melting amorphous polylactic acid and mixing it with a solid reinforcing material, for example, semi-crystalline PLA in fiber or particulate form. Other materials can also be used for reinforcement. The composite material can then be used in a downhole application, such as a screen coating and tubing. Suitable tubing applications include, but are not limited to, production tubing and coiled tubing. In some embodiments, the composite material may be used to completely or substantially plug the openings in a sand control screen, the coated sand control screen is then placed into the subterranean formation and then the coating is allowed to degrade over time such that the screen once again has openings for fluid flow.

Polylactic acid or polylactide (PLA) is a thermoplastic aliphatic polyester often derived from renewable resources. Polylactic acid is considered biodegradable under certain conditions and may be degraded through a hydrolysis reaction. Generally speaking, amorphous polylactic acid degrades more readily than crystalline polylactic acid, which is generally a more pure form of poly-D-lactide or poly-L-lactide. During the degradation of polylactic acid, an acid is generated which can then dissolve or react with downhole materials including, but not limited to, acid soluble bridging agents (calcium carbonate), polymers such as pH reversible gels, and shrinkable clays.

In some embodiments, the amorphous polylactic acid may be particles, rods, fibers, flakes, or a thin film. The amorphous polylactic acid may be present in about 50 to about 99% by weight of the composite material and preferably about 60 to about 80% by weight of the composite material.

Solid reinforcing materials suitable for use in the present invention may be water insoluble, water-soluble, or acid-soluble. In some embodiments, the solid reinforcing material may be a polymeric material, inorganic filler, or a salt. In some preferred embodiments, the solid reinforcing material is itself degradable. By way of example, in some embodiments the solid reinforcing material may be crystalline polylactic acid, semi-crystalline polylactic acid, calcium carbonate, sodium chloride, aluminum silicate, calcium sulfate, calcium chloride, solid anhydrous borate materials, magnesium oxide, talc, silicate, mica, carbon black, carbon fiber, carbon nanotube, metal particles or fibers, wollastonite, natural fibers such as cellulose and nylon, and combinations thereof.

In other embodiments, the solid reinforcing material may be sand, bauxite, ceramic materials, glass materials, polytetrafluoroethylene materials, nut shell pieces, cured resinous particulates, nut shell pieces, seed shell pieces, fruit pit pieces, cured resinous particulates comprising fruit pit pieces, wood, composite particulates, carbons, metal oxides, and combinations thereof. The solid reinforcing material may be present in about 1 to about 50% by weight of the composite material.

In some embodiments, the solid reinforcing material may be powdered, particulate, or fiber-like. The average size of the particulate or powder may range from about 1nm to about 1mm. Without being limited by theory, it is believed that smaller particulates provide better strength reinforcement as they can easily be dispersed in a given matrix. The average fiber diameter may range from about 1 micron to about 1 mm. The average fiber may range from about 1 mm to about 100 mm in size. These particulates may or may not be monodispersed. Without being limited by theory, it is believed that a smaller particle size range results in better reinforcement of the amorphous polylactic acid. The particular size of the reinforcing material may be modified as desired.

In some embodiments, fibrous crystalline polylactic acid may be used as the solid reinforcing material. These fibers may be processed using conventional melt spinning processes or other techniques.

In some embodiments, the reinforced amorphous polylactic acid material is used in a downhole application. In some embodiments, the reinforced amorphous polylactic acid material may be used to as a coating material to coat downhole devices and tools. Suitable downhole tools include, but not limited to, sand control screens, testing downhole tools, perforating downhole tools, completion downhole tools, drilling downhole tools, logging downhole tools, treating downhole tools, circulation valve well downhole tools, packers, well screen assemblies, bridge plugs, frac plugs, cementing tools, coil tubing, casing, and fishing downhole tools.

To facilitate a better understanding of the present invention, the following examples of preferred embodiments are given. In no way should the following examples be read to limit, or to define, the scope of the invention.

### EXAMPLE 1

The reinforced amorphous polylactic acid was prepared in the following manner. Amorphous polylactic acid (commercially available under the trademark “ECORENE® NW 60” from ICO Polymers) was reinforced with a high degree of crystallinity but low molecular weight crystalline polylactic acid powder (commercially available under the trademark “ECORENE® 30-35AP” from ICO Polymers). The composite comprising 70% of the amorphous polylactic acid and 30% of the semi-crystalline polylactic acid powder was mixed in a Brabender® mixer (commercially available from C.W. Brabender® Instruments, Inc.) at 135° C. The resulting mixture was stiffer than neat amorphous polylactic acid by itself. The mixture was then heated in a 400° F. vacuum oven for one hour. This heated mixture was observed to be much more fluid and easier to pump than the neat amorphous polylactic acid heated under the same condition.

This Example illustrates, among other things, the ease of manufacturing involved in the making of reinforced amorphous polylactic acid. The advantage of this mixture is that it should provide better mechanical properties than amorphous PLA at elevated temperature (but lower than the melting point of the neat crystalline PLA, such as 180° F.), while being easier to pump at temperatures higher than the melting point of the neat crystalline PLA, such as 400° F. This provides the advantage of both pumping ability to make the coating at higher temperature, as well as better mechanical properties at a somewhat lower operation temperature. The reinforced amorphous polylactic acid is also easier to handle than crystalline polylactic acid, particularly in large scale scenarios. Overall, this composite material should provide the advantage of both pumping ability to make a coating at higher temperature than crystalline polylactic acid as well as providing better mechanical properties than amorphous polylactic acid.

### EXAMPLE 2

In this Example, the extrusion characteristics of amorphous polylactic acid were tested against different temperatures and pressures. In each test, amorphous polylactic acid was molded into a 2.5″×0.25″ (diameter×thickness) wafer. Next, the wafer was placed into a high pressure high temperature (HPHT) cell that contains a 2.5″×0.25″ (diameter x thickness) metal disc with a hole (0.44″ or 0.25″) at the center as the bottom plate. The HPHT cell was filled with 250 mL of Duncan, Okla. tap water. The wafer was then heated to a set temperature ranging from 130° F. to 180° F. for 1 hour. After the elapsed time, pressure was ramped up and applied to the wafer to test the extrusion properties of the sample wafer. The testing conditions for each wafer are shown in Table 1 below.

TABLE 1

| | Metal Disc Hole | Temperature | |
|---|---|---|---|
| Test # | Diameter (inches) | (° F.) | Pressure (psi) |
| 1 | 0.44 | 180 | 100 |
| 2 | 0.25 | 180 | 140 |
| 3 | 0.25 | 150 | 200 |
| 4 | 0.25 | 130 | 200 |

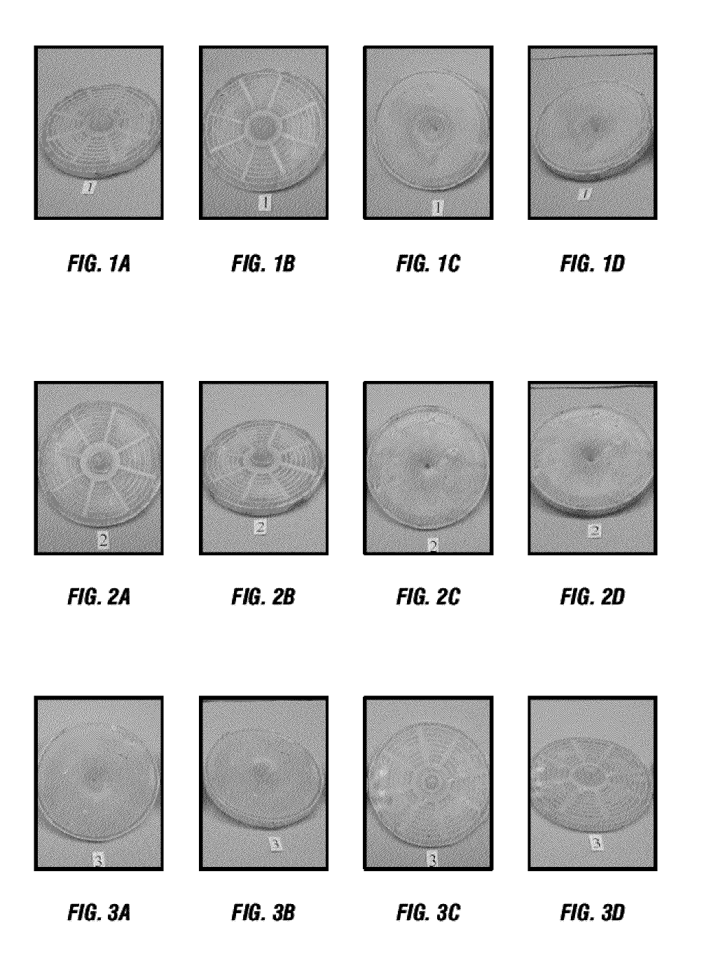

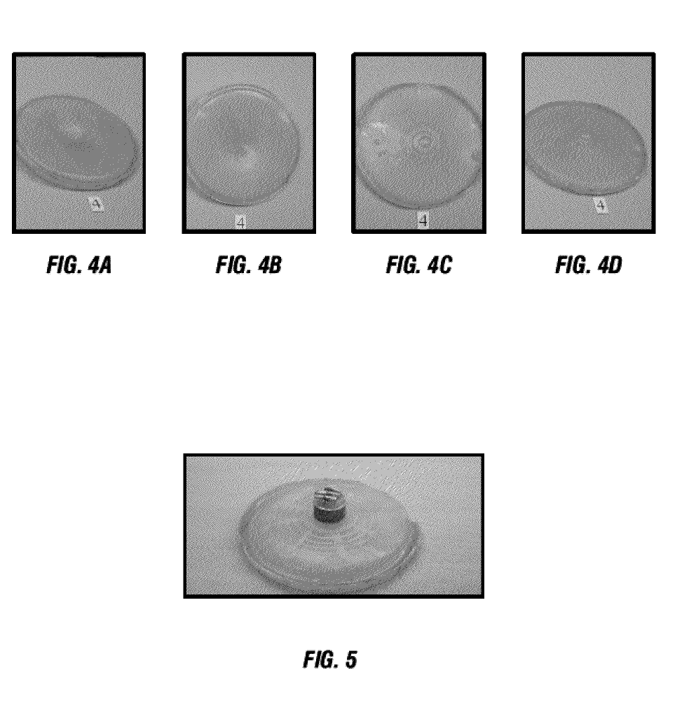

The results of Test 1 are shown in FIGS. 1A-1D. These figures show that an amorphous polylactic acid wafer deforms and extrudes under 180° F. and 100 psi differential pressure. FIGS. 1A-1B represent bottom views of the wafer. These figures show extrusion of polylactic acid from the center hole of the metal disc; the wafer blew out in a very short time after it was exposed to 180° F. and 100 psi. FIGS. 1C-1D show top views of the wafer. Results of Test 2 are shown in FIGS. 2A-2D. FIGS. 2A-2B are similar to 1A-1B as bottom views of the wafer show extrusion of polylactic acid from the center hole of the metal disc and it was blown out after being exposed to 180° F. and 140 psi in a very short time. FIGS. 2C-2D show top views of the same wafer in FIGS. 2A-2B. Results of Test 3 are shown in FIGS. 3A-3D. FIGS. 3A-3B show protrusion and extrusion of the amorphous polylactic acid from the center hole of the metal disc after being treated at 150° F. and 200 psi for 2 hours. FIGS. 3C-3D represent top views of the tested wafer. In Tests 1-3, the temperature of the HPHT cell is greater than the glass transition temperature (−136° F.) of amorphous polylactic acid. Test 4 results are shown in FIGS. 4A-4D. FIGS. 4A-4B show bottom views of the wafer after the wafer has been exposed to 130° F. and 200 psi for 2 hours. Slight protrusion of the center hole can be seen. The wafer however does not display grids from the cell lid as the temperature did not exceed the glass transition temperature. FIGS. 4C-4D show top views of the tested wafer. These figures show that an amorphous polylactic acid can deform under relatively modest temperatures and pressures. In Tests 1-3, the amorphous wafers were subjected to temperatures above its T_{g} and demonstrated poor mechanical properties including deformation and extrusion. In Test 4, the amorphous wafer was subjected to a temperature below its T_{g} and thus did not deform to the shape of the cell lid but did show some deformation.

This Example illustrates, among other things, that amorphous polylactic acid generally has poor mechanical properties such as deforming and extruding under relatively high temperature and pressures.

### EXAMPLE 3

In this Example, an amorphous polylactic acid wafer was tested with a wrapped screen under conditions closely simulating real downhole conditions (PLA-pipe with 0.25″ ID and 0.15″ thickness-wrapped screen). The screens were installed into a test fixture. The amorphous wafer and wrapped screen were tested in a HPHT cell at 180° F. and 200 psi. The wrapped screen was placed behind the metal disc.

The result of the test is shown in FIG. 5. In this figure, the amorphous polylactic acid wafer did not hold pressure as extrusion can be clearly seen in the first metal grid. However, the extrusion never reaches the wrapped screen. It only took a few minutes for the integrity of the PLA wafer sample to give way and release water from the cell.

This Example shows, among other things, the failure of amorphous polylactic acid installed with a screen to resist deformation and extrusion under simulated downhole conditions.

### EXAMPLE 4

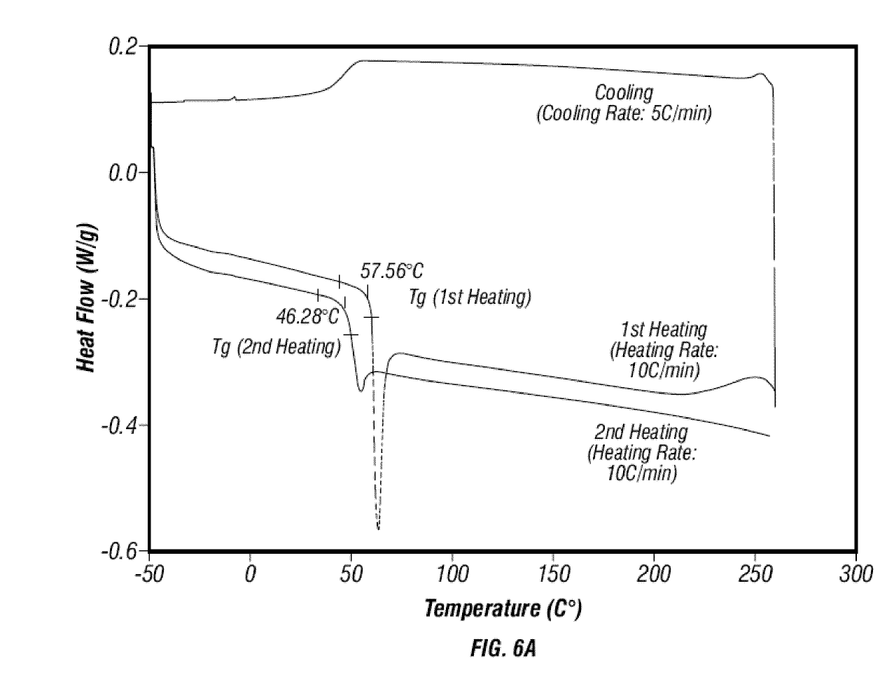

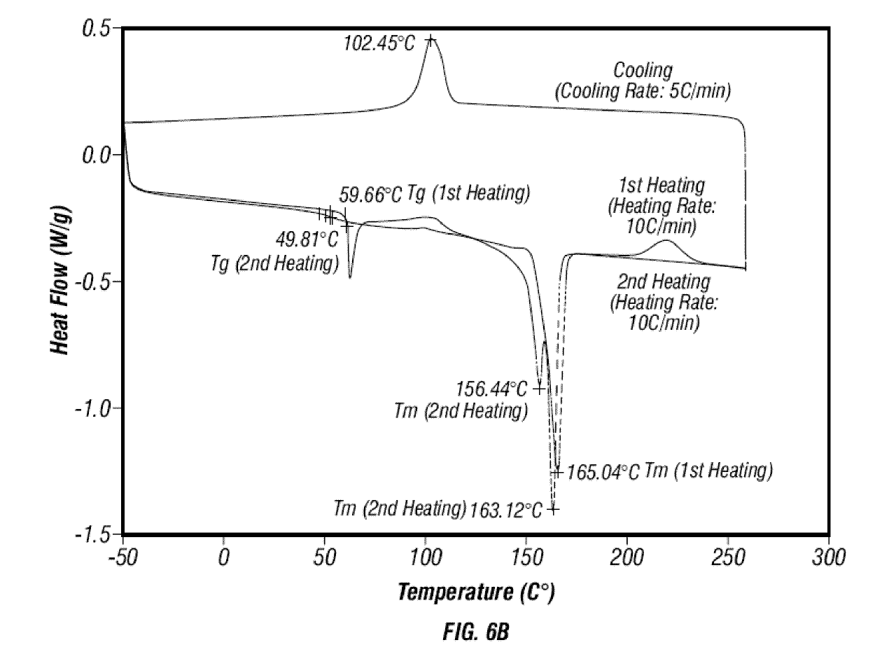

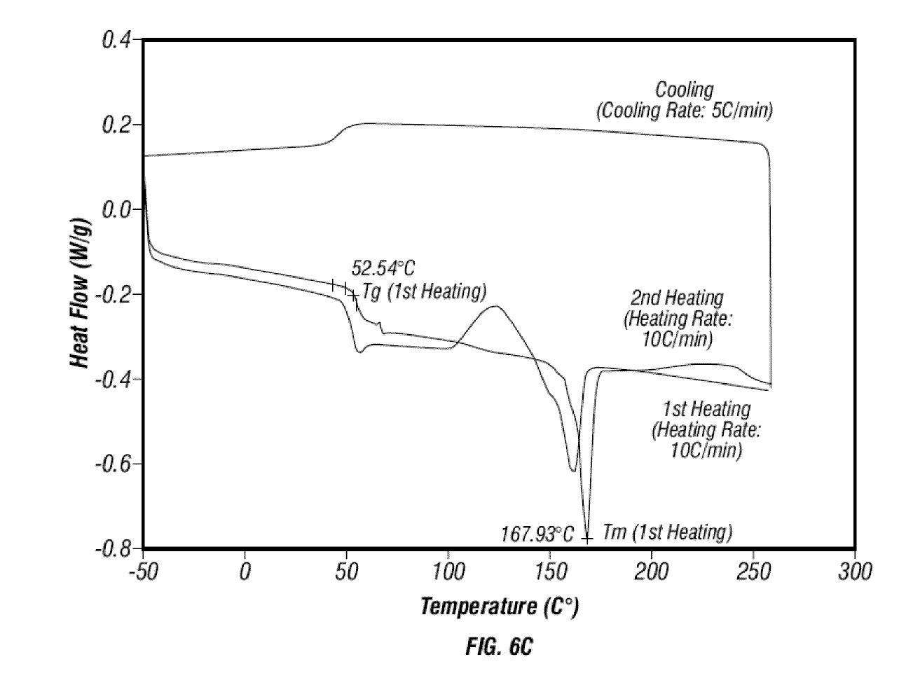

In this Example, the reinforced amorphous polylactic acid was prepared similarly as described in Example 1. Amorphous polylactic acid (commercially available under the trademark “ECORENE® NW 60” from ICO Polymers) was reinforced with a high degree of crystallinity and high molecular weight polylactic acid powder (commercially available as “FDP-S820-05” from Halliburton Energy Services, Inc.). The composite comprising 70% of the amorphous polylactic acid and 30% of the semi-crystalline polylactic acid powder was mixed in a Brabender® mixer (commercially available from C.W. Brabender® Instruments, Inc.) at 135° C. The different polylactic acid materials were tested for their thermal transitions. Specifically heat flow was measured against temperature using differential scanning calorimetry (DSC). DSC is carried out with hermetic pans under N₂ atmosphere with approximately 10 mg of sample using a Model Q200 from TA Instruments. The scans are run first from −50° C. to 250° C. at a ramp rate of 10° C./min, then ramped down to −50° C. at a ramp rate of 5° C./min, and finally a second ramp to 250° C. at a ramp rate of 10° C./min. In separate tests, amorphous polylactic acid, crystalline polylactic acid powder and reinforced amorphous polylactic acid (70% amorphous polylactic acid and 30% polylactic acid powder) were tested. These results are shown in the plots shown in FIGS. 6A-6C, respectively. All the glass transition temperatures (T_{g}) reported here are from the first heating cycle.

FIG. 6A shows that amorphous polylactic acid sample showed a glass transition temperature at 58° C. (136° F.). The thermal transitions were apparent as liquid-glass transition and melting transition both require additional heat as compared to the reference. Crystalline polylactic acid displayed a slightly higher glass transition temperature around 60° C. (140° F.) and a melting point around 165° C. (329° F.) as shown in FIG. 6B. Finally, the reinforced amorphous polylactic acid (70% amorphous polylactic acid and 30% polylactic acid powder with a high degree of crystallinity and high molecular weight) sample displayed a glass transition temperature of 52° C. (126° F.) and a melting temperature of 167° C. (332° F.).

Thus, this Example shows, among other things, that the reinforced amorphous polylactic acid has a glass transition temperature which comes from the amorphous portions of the semi-crystalline polylactic acid and amorphous polylactic acid and the melting temperature which comes from the crystalline portion of semi-crystalline PLA.

### EXAMPLE 5

In this Example, the reinforced amorphous polylactic acid from Example 4 was molded into wafers and tested for mechanical stability under high temperature and pressure. The 70% amorphous PLA/30% crystalline PLA wafer (high degree of crystallinity and high molecular weight) was molded. The wrapped screen was placed in the HPHT cell. On top of the wrapped screen, a 2.5″×0.25″ metal disc (Diameter×Thickness) which contains a 0.25″ hole in the center was placed. Next, the reinforced amorphous polylactic acid wafer was placed in a HPHT cell. The cell was filled with 250 mL Duncan, Okla. tap water and heated to 180° F. for 2 hours.

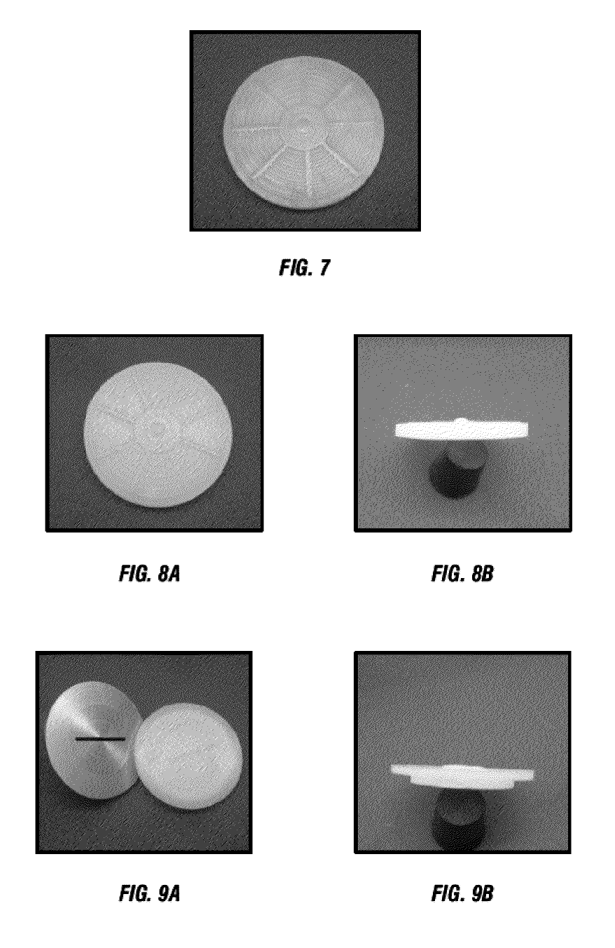

After the elapsed time, the first wafer was subjected to a pressure of 200 psi. FIG. 7 shows the reinforced amorphous polylactic acid wafer after being held at 200 psi for more than 2 hours. The imprints of the HTHP lid can be seen on the wafer. No extrusion was observed on the wafer. No leaks were detected. This reinforced PLA composite wafer is visibly superior to the amorphous wafers tested under milder test conditions (Tests 1-4).

A second reinforced PLA composite wafer (70% amorphous PLA/30% crystalline PLA, same recipe as Example 4) with a wrapped screen was subjected to a pressure of 500 psi for 2 hours. FIG. 8 shows the resulting reinforced amorphous polylactic acid wafer after being held at 500 psi for more than 2 hours. The wafer showed no extrusion and a small protrusion in the center (¼ OD×0.063″). No leaks were detected.

### EXAMPLE 6

In this Example, a slot test was performed on the reinforced amorphous polylactic acid wafer (same recipe as Example 4). A wafer of 70% amorphous PLA/30% crystalline PLA was molded. The wafer was then tested in a HPHT cell containing 250 mL Duncan, Okla. tap water. The wafer was placed inside the cell against a slot model and heated to 180° F. for 2 hours. The dimensions of the slot model was 1.5″L×0.065″W×0.125″ thick. The wafer was modified to allow the use of 0.125″ thick slot model. The thickness of the polylactic acid wafer at the slot was 0.25″. The lip portion of the water was 0.125″ allowing the combined installation to include the slot model. After the elapsed time, pressure was applied at 500 psi against a slot model. The polylactic acid wafer was held under 500 psi for more than 2 hours at 180° F. with no leaks. An approximately 1.25″ long×0.065″ wide ×0.05″ deep protrusion was observed on the wafer (FIGS. 9A-9B).

Thus, this Example illustrates, among other things, the mechanical strength of reinforced amorphous polylactic acid under relatively harsh temperature and pressure.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
providing an amorphous polylactic acid and a solid reinforcing material;
forming a composite material by melting the amorphous polylactic acid and mixing it with the solid reinforcing material; and,
using the composite material in a downhole application.

2. The method of claim 1 wherein the solid reinforcing material is degradable.

3. The method of claim 1 wherein the reinforcing material exhibits a physical shape selected from the group consisting of a powder, a particulate, or a fiber.

4. The method of claim 1 wherein the reinforcing material has a mean size of about 1nm to about 100 mm.

5. The method of claim 1 wherein the solid reinforcing material comprises a material selected from the group consisting of: polymeric materials; inorganic filler or a salt; crystalline polylactic acid; semi-crystalline polylactic acid; calcium carbonate; sodium chloride; aluminum silicate; calcium sulfate; calcium chloride; solid anhydrous borate materials; magnesium oxide; talc; silicate; mica; carbon black; carbon fiber; carbon nanotube; metal particles or fibers; wollastonite; cellulose fibers; nylon fibers; sand; bauxite; ceramic materials; glass materials; polytetrafluoroethylene materials; nut shell pieces; cured resinous particulates; nut shell pieces; seed shell pieces; fruit pit pieces; wood; metal oxides; and combinations thereof.

6. The method of claim 1 wherein the composite material is used as a coating on a downhole tool comprising a tool selected from the group consisting of:
a sand control screen, a testing downhole tool, a perforating downhole tool, a completion downhole tool, a drilling downhole tool, a logging downhole tool, a treating downhole tool, a circulation valve well downhole tool, a packer, a well screen assembly, a bridge plug, a frac plug, a kickoff plug, a cementing tool, a coil tubing, a casing, a fishing downhole tool, and any combination thereof.

7. The method of claim 1 wherein the amorphous polylactic acid is present in about 50 to about 99% by weight of the composite material.

8. The method of claim 1 wherein the solid reinforcing material is crystalline polylactic acid and wherein the crystalline PLA is present in about 1 to about 50% by weight of the composite material.

9. The method of claim 1 wherein the amorphous polylactic acid is present in about 60 to about 80% by weight of the composite material.

10. A method comprising:
forming a composite material by melting an amorphous polylactic acid and mixing it with a solid reinforcing material;
coating the composite material onto a screen for use in a downhole application such that the screen openings are substantially plugged;
placing the coated screen into a wellbore wherein the coated screen acts as a wash pipe that gradually becomes a screen as the amorphous polylactic acid degrades.

11. The method of claim 10 wherein the solid reinforcing material is degradable.

12. The method of claim 10 wherein the reinforcing material exhibits a physical shape from selected from the group consisting of a powder, a particulate, or a fiber.

13. The method of claim 10 wherein the solid reinforcing material is crystalline polylactic acid.

14. The method of claim 10 wherein the amorphous polylactic acid is present in about 50 to about 99% by weight of the composite material.

15. The method of claim 13 wherein the crystalline polylactic acid is present in about 1 to about 50% by weight of the composite material.

16. The method of claim 10 wherein the amorphous polylactic acid is present in about 60% to about 80% by weight of the composite material.

17. A method comprising:
providing a composite material by melting an amorphous polylactic acid and mixing it with a solid reinforcing material; and,
forming a downhole tubular with the composite material.

18. The method of claim 17 wherein the tubular is a coiled tubing, or a production tubing.

19. The method of claim 17 wherein the solid reinforcing material is crystalline polylactic acid.

20. The method of claim 17 wherein the amorphous polylactic acid is present in about 50 to about 99% by weight of the composite material.
